(19) United States
(12) Patent Application Publication
(10) Pub. No.: US 2009/0322070 A1
(43) Pub. Date: Dec. 31, 2009

(54) Method and system for hiding information

(76) Inventors: Jay Reichelsheimer, Shelton, CT (US); Luis A. Sanchez, Troy, NY (US)

Correspondence Address: PITNEY BOWES INC., 35 WATERVIEW DRIVE, MSC 26-22, SHELTON, CT, 06484-3000, US

(21) Appl. No.: 11/645,910

(22) Filed: Dec. 27, 2006

(51) Int. Cl. B42D 15/00; B41J 2/01

(52) U.S. Cl. 283/5; 283/85; 283/114; 347/107

(57) ABSTRACT

A printed indicium comprising a first section comprising a first ink having a first color under normal daylight; and a second section comprising a second different ink, wherein the second different ink comprises a photochromic or thermochromic ink which is not visible under normal daylight, the second section further comprising a third different ink which comprises a photochromic or thermochromic ink which is visible under normal daylight.

### BACKGROUND OF THE INVENTION

1. Field of the Invention

The invention disclosed herein relates to hiding information and, more particularly, to a method and system for hiding voting information to preserve confidentiality and prevent fraud.

2. Background Information

Voting for candidates in the United States is typically performed using mechanical voting machines at predetermined polling places. However, if an individual is unable to go to the polling place at which he or she is registered, an absentee ballot may be used to allow the individual to cast the vote. Typically, the user of an absentee ballot selects his or her choices on a ballot and returns the ballot to the election official by mail.

In order for the ballot to be counted, it must comply with the applicable election laws and be valid. For absentee ballots to be valid, for example, the ballot must have been created, i.e. completed by the voter, in a timely manner and submitted for return to the election officials. The election officials also verify that the voter is properly registered in that voting district and that they have not already voted in the election.

Other important concerns include protecting the voter's privacy and prevention of fraud.

Accordingly, in a voting by mail system there is a desire to hide the user's personal and confidential information from the vote that was placed in order to protect the user's privacy. There is also a desire for a method and system in which a governing body can verify the user's personal and confidential information to insure that a valid vote is cast and thus prevent fraud. There is a further desire to hide information in other secure documents to preserve confidentiality and prevent fraud.

### SUMMARY OF THE INVENTION

In accordance with one aspect of the invention, a printed indicium is provided comprising: a first section comprising a first ink having a first color under normal daylight; and a second section comprising a second different ink, wherein the second different ink comprises a photochromic or thermochromic ink which is not visible under normal daylight, the second section further comprising a third different ink which comprises a photochromic or thermochromic ink which is visible under normal daylight.

In accordance with another aspect of the invention, a system for printing indicium on an item is disclosed comprising: a print head system adapted to print at least three different inks onto the item, the print head system comprising: a first supply of a first ink having a first color under normal daylight; a second supply of a second different ink, the second different ink comprising a photochromic or thermochromic ink which is not visible under normal daylight; and a third supply of a third different ink, the third different ink comprising a photochromic or thermochromic ink which is visible under normal daylight; and a controller for controlling application of the first, second and third inks by the print head system on the item, wherein the controller is adapted to print the inks such that the first and third inks are visible under normal daylight and the second ink is not visible under normal daylight, and the third ink is not visible when exposed to a photochromic or thermochromic excitation source and the second ink is visible when exposed to a photochromic or thermochromic excitation source.

In accordance with another aspect of the invention a method of printing indicium on an item is disclosed comprising steps of: printing a first marking on the item in a first section with a first ink, the first ink having a first color under normal daylight; printing a second marking on the item in a second section with a second different ink comprising a photochromic or thermochromic ink which is not visible under normal daylight; and printing a third marking on the item in the second section with a third different ink comprising a photochromic or thermochromic ink which is visible under normal daylight.

In accordance with another embodiment of the invention, a voting article is disclosed comprising: an envelope having an opaque window, the opaque window comprising a photochromic or thermochromic material; a voting ballot located inside the envelope, the voting ballot comprising a first section comprising a first ink having a first color under normal daylight; and a second section comprising a second different ink. The second different ink comprises a photochromic or thermochromic ink which is not visible under normal daylight and the second section further comprises a third different ink which comprises a photochromic or thermochromic ink which is visible under normal daylight. User information including at least one of a barcode, voter's name, address and signature is printed on the ballot with the second different ink and is not visible through the window until activated by a suitable photochromic or thermochromic excitation source.

In accordance with a further embodiment of the invention, a method of hiding and verifying information in a voting system using a photochromic or thermochromic ink is disclosed. The method comprises: printing a first marking on a voting ballot in a first section with a first ink, the first ink having a first color under normal daylight, wherein the step of printing a first marking includes printing candidate information as the first marking; and printing a second marking on the voting ballot in a second section with a second different ink comprising a photochromic or thermochromic ink which is not visible under normal daylight, wherein the step of printing a second marking comprises printing at least one of a bar code and voter identification information as the second marking. The method further comprises printing a third marking on the voting ballot in the second section with a third different ink comprising a photochromic or thermochromic ink which is visible under normal daylight, wherein the step of printing a third marking comprises printing a signature block in which a voter inserts a signature as the third marking; and verifying the authenticy of the voting ballot by subjecting the second ink and the third ink to a photochromic or thermochromic excitation source by a governing body to expose the voter identification information and voter signature.

### BRIEF DESCRIPTION OF THE DRAWINGS

The foregoing aspects and other features of the present invention are explained in the following description, taken in connection with the accompanying drawings, wherein:

FIG. 1 shows a printed indicium incorporating features of embodiments of the invention;

FIGS. 2 and 3 schematically show the functioning of second ink and third ink, respectively, in accordance with embodiments of the invention;

FIG. 4 shows a voting ballot inside an envelope having an opaque window, in accordance with embodiments of the invention;

FIG. 5 shows a diagrammatic view of a system for printing an indicium, in accordance with embodiments of the invention; and

FIG. 6 show a diagrammatic view of a system for detecting hidden information, in accordance with embodiments of the invention.

### DETAILED DESCRIPTION

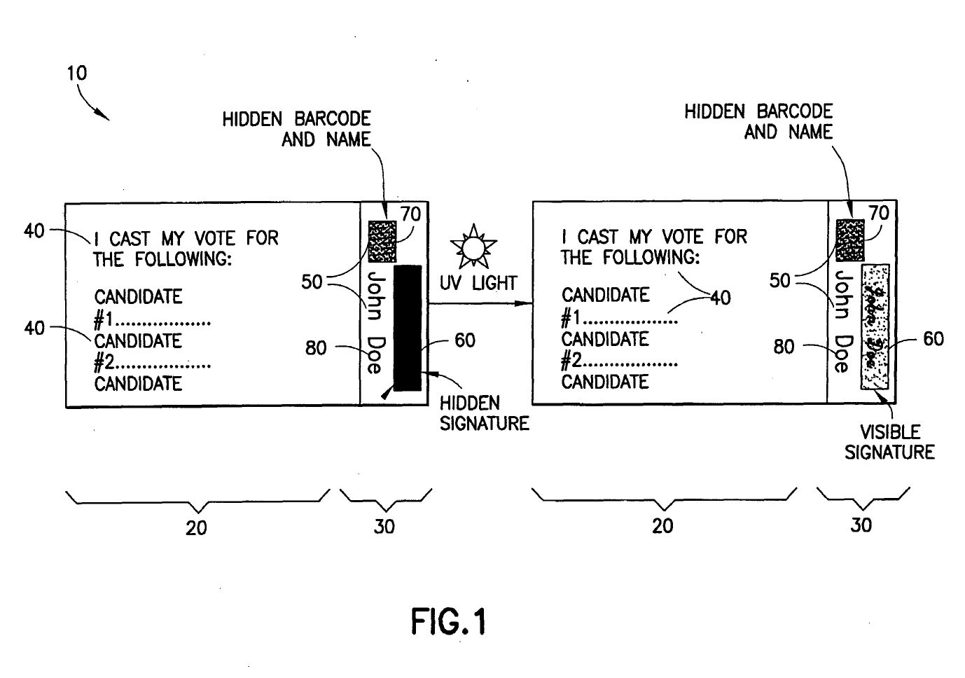

Referring to FIG. 1, there is shown a printed indicium 10 incorporating features of the invention. Although the invention will be described with reference to the embodiments shown in the drawings, it should be understood that the invention can be embodied in many alternate forms of embodiments. In addition, any suitable size, shape or type of elements or materials could be used.

In the embodiment shown, the printed indicium 10 generally comprises a voting ballot that can be used in a voting system in accordance with the invention. However, in alternate embodiments, features of the invention could be used in any suitable type of printed indicium. For example, features of the invention could be used with indicium printed on other substrates such as other secure documents, tags, cards or similar items. The indicium in the embodiment shown in FIG. 1 comprises a first section 20 and a second section 30. The first section 20 comprises a first ink 40 having a first color under normal daylight. The second section 30 comprises a second different ink 50, wherein the second different ink 50 comprises a photochromic or thermochromic ink which is not visible under normal daylight. The second section 30 further comprises a third different ink 60 which comprises a photochromic or thermochromic ink which is visible under normal daylight.

In the embodiment shown in FIG. 1, the first ink 40 may be used to list the candidates from which the voter using the ballot 10 may select. The voter may select a candidate (s) in a variety of ways depending upon the application election rules. For example, the ballot 10 may include a place adjacent to each candidate in which the voter marks his or her selection. In alternate embodiments, the first ink 40 may be used to show any other desirable words, markings or symbols. First ink 40 is typically a blue or black ink. However, any suitable, visible color may be employed for the first ink 40. The color of the first ink 40 does not become invisible if exposed to, for example, UV light or heat. Any suitable type of visible ink may be used for first ink 40 including, for example, laser printer ink or ink jet ink may be employed. Similarly, first ink 40 may also comprise more than one ink.

The second different ink 50 of the second section 30 comprises a photochromic or thermochromic ink which is not visible under normal daylight. Thus, advantageously, the information printed with ink 50 can remain hidden until it is activated by an appropriate energy source (e.g., photochromic excitation or thermochromic excitation source). After activation, the information will be human or machine readable. Removal of the energy source results in a reversal of the process and the information becomes hidden again. Thus, in the embodiment shown in FIG. 1, second different ink 50 may be used to print a two dimensional bar code 70. Second different ink 50 may also be used to print the user's identification information 80, such as name and address. Thus, advantageously, a voting card may be constructed wherein identifiable information, such as the user's name and address remains invisible until activated with an energy source, such as a photochromic excitation source including suitable UV light or a thermochromic excitation source including heat. After activation, the user information may be checked for validity, such as by being manually or automatically checked by a governing source. The information will then rapidly become invisible once the energy source is removed. Advantageously, this is useful to hide predetermined information, but does not help to protect “user generated” confidential information, such as a signature. Such information is typically written with a ball point pen.

Accordingly, the second section 30 may further comprise a third different ink 60 which comprises a photochromic or thermochromic ink which is visible under normal daylight. Ink 60 may be used to print a solid block or other type/shape which can change from colored to colorless upon activation by a photochromic or thermochromic excitation source including, for example, suitable UV light or heat. In the embodiment shown, the user may be instructed to place his/her signature in the solid block. Ball point pen ink written on black paper has very low contrast. It is unable to be copied and is very difficult to see. For example, an ultraviolet black light can instantly reveal all information for signature and barcode verification. After the UV blacklight is removed, the photochromic dyes will reverse and the information will be hidden again.

By combining the foregoing transition effects, all confidential information can be hidden, and revealed at the appropriate time such as when the voting ballot 10 is verified by a governing body. Advantageously, in addition to providing the voter with confidentiality and allowing verification of the vote, the voting ballot 10 or card itself is difficult to duplicate. Thus, embodiments of the invention provide a user friendly system while also providing additional security.

In alternate embodiments, the second ink 50 and third ink 60 may be used for any other desirable words, markings or symbols. The second and third inks, 50, 60, may also each comprise more than one ink.

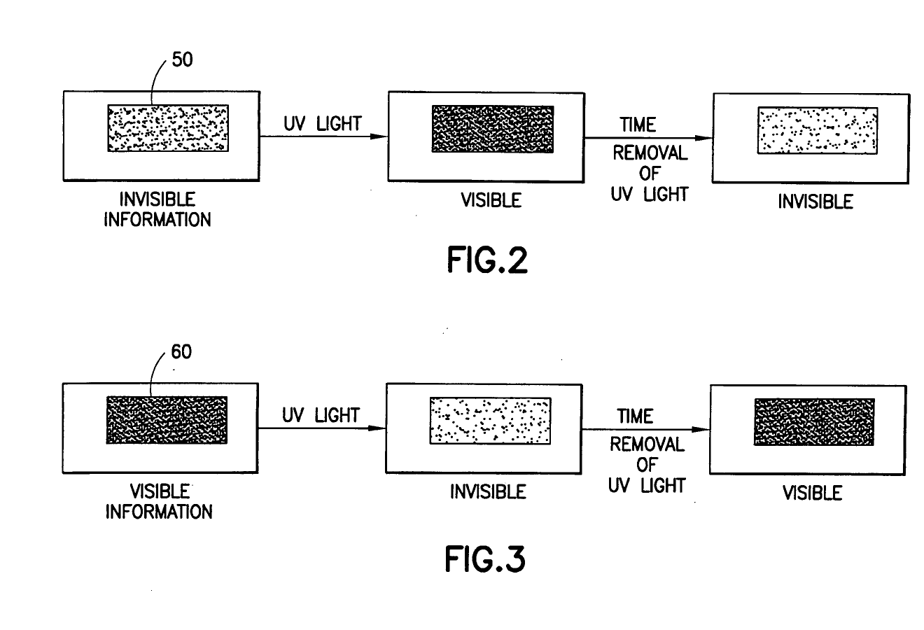

FIG. 2 shows an example of the functioning of second ink 50 as a photochromic ink. As shown therein, second ink 50 is used to print the desired information on a substrate. This information is invisible under normal daylight. Upon exposure to a suitable UV light, the information becomes visible. Upon removal of the suitable UV light, the information advantageously becomes hidden again.

FIG. 3 shows an example of the functioning of third ink 60 as a photochromic ink. As shown there, third ink 60 is used to print the desired information on a substrate. Unlike the second ink 50, this information is visible under normal daylight. Upon exposure to a photochromic excitation source, such as a suitable UV light, the information becomes invisible. Upon removal of the excitation source, the information advantageously becomes visible again.

The material can be tailored to work with different wavelengths and different light intensities. Sources of activation, such as sunlight, may generally be avoided for embodiments of the invention. A broad spectrum white light such as a Halogen lamp may be employed. The activation may be tailored to be, for example, X times a desired intensity to ensure that a special lamp may be used. A suitable UV lamp includes EN-280L (two 8 W bulbs) from Spectronics Corp., New York.

Photochromism is generally understood to mean a light-induced reversible change of color of a substance. During this transition, the color or absorption spectrum of the initial substance changes. The reverse reaction may then be initiated by, for example, exposure to light of a different wavelength, typically a UV light. Photochromic substances are used today in applications such as sunglasses that automatically darken when you walk outdoors.

Photochromic dyes/inks are commercially available in a variety of colors from companies such as John Robinson, www.photochromic.co.uk or Spectra Group Limited, www.sglinc.com. The table below shows several Spectra Group Limited Dye Examples, most of which are irreversible “negative photochromics.” They may be used, for example, to hide the information until it reaches the voting authority and then the information may be revealed, but the information would stay visible thereafter. Examples of materials that are fully reversible include WC AG 1-6 (Blue) and SGL-440 (Red) also from Spectra Group Limited.

| | | | Color |
|---|---|---|---|
| | | Initial | After |
| SPECTRACOLOR | Matrix | Color | Exposure |
| C Blue 50 | Cationic curable | Colorless | Blue |
| | concentrate, epoxides | | |
| C BL-DAA-E | Solvent borne | Colorless | Blue |
| C BL-PEPC-E | concentrate (DAA or | Colorless | Blue |
| | PEPC), for cationic | | |
| | energy curable systems | | |
| C BL-285 | Concentrate in acrylate | Colorless | Blue |
| C MAG-285, | monomer diluents | Colorless | Magenta |
| 339 | (THFPA) , for free | | |
| C OR-285 | radical energy curable | Colorless | Orange |
| | systems | | |
| C BL-DMAA | Concentrate in tert- | Colorless | Blue |
| | amine, recommended for | | |
| | free radical energy | | |
| | curable systems | | |
| C Mag PC2 | Concentrate in acetone | Colorless | Magenta |
| C Rev Mag | | Colorless | Magenta |
| PC2 | | | with fast |
| | | | fade |
| C OR PC3 | | Colorless | Orange |
| C BL PC 4 | | Colorless | Blue |
| C OR RT | | Magenta/Red | Colorless |
| C QR-ET-NS-M | High solids | Magenta/Red | Colorless |
| C ER-ET-NS | concentrates | Orange | Colorless |
| C WC Ag 1-8 | Waterborne concentrates | Blue | Colorless |
| C WC TU1 | Concentrate in acrylate | Blue | Colorless |
| | monomer, miscible with | | |
| | water | | |

Examples of photchromic ink compositions include a desired photochromic dye and a suitable carrier for the dye, such as an aqueous based carrier.

More particularly, there are commercially available suitable flexo, screen and UV curable inks, which may be used to produce static images on a printing press such as a solid block.

Suitable hot melt photochromic inks are described in U.S. Pat. No. 5,593,486 and are digitally printable. Inkjet printable formulations, which work in a normal HP inkjet printer, are also described in U.S. Pat. No. 5,551,973. U.S. Pat. No. 6,858,564 further describes photochromic materials. Commercially available aqueous inks may also be obtained from Sun Chemical under ThermaSOLV/SEREND. See also www.sunchemical.com.

If a black to colorless ink is not readily available, it may be created by mixing two or more colors such as blue and orange. The rate of change of these dyes may also be controlled by selection to produce rapid development and reversal.

Thermochromic inks function similarly to the afore-described photochromic inks, however, the activating source is heat. The dyes or pigments of thermochromic inks may change color reversibly in response to changes in temperature. For example, if a thermochromic ink is exposed to a particular activation temperature it may visually change from colored to colorless. Activation temperatures may range from, for example, −10° C. and 69° C. Upon cool down, the thermochromic ink returns to the original state and reversibly changes color. The color and activation temperature may be selected, as desired.

Thus, it is possible for certain invisible thermochromic inks to become visible upon generated heat. Typical heat sources include IR lamps, hot air guns, heated belts or platforms while processing. It is thus possible to employ thermochromic inks which turn visible upon heat activation, e.g. Leuco dyes that may be used in cash register receipts and other thermal papers. It is also thus possible to have a visible thermochromic ink turn invisible. An example of this material is Leuco Dye Powder (LD-P) Black from Color Change Corporation, Illinois. Material is commercially available in many activation temperatures. Color Change Corporation's website discloses various activation temperatures and colors.

Examples of thermochromic materials are also described in U.S. Pat. No. 6,858,564. Thermochromic inks are available from a number of commercially available sources including H.W. Sands Corp., Florida. See also U.S. application Ser. No. ______ entitled Secure Envelope and Method for Securing Information [Attorney Docket G293], the contents of which are hereby incorporated by reference.

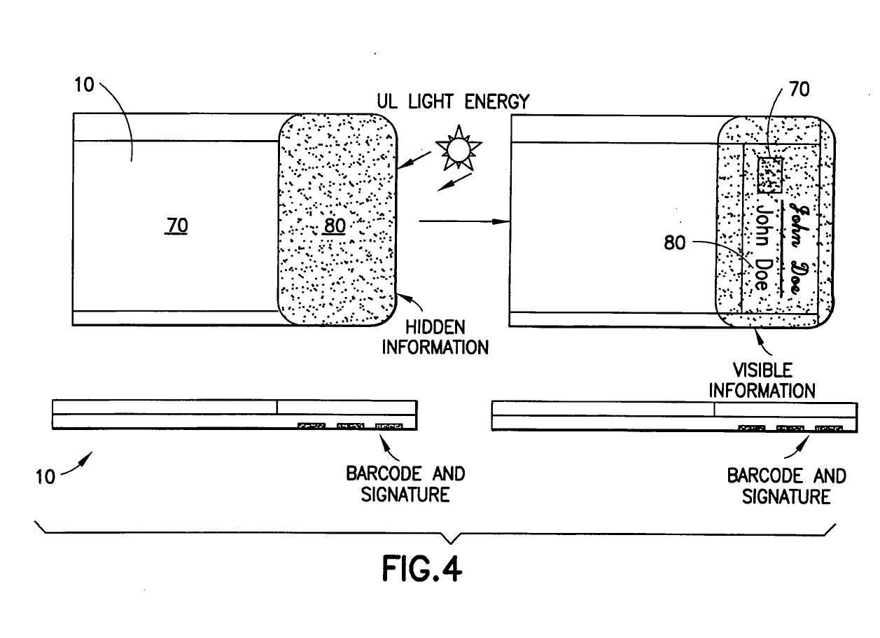

In accordance with another embodiment of the invention, information may be hidden with a photochromic or thermochromic colored window, which will change to clear upon exposure to a photochromic or thermochromic excitation source, including suitable UV light or heat. For example, a conventional plastic or polymeric envelope window may be mixed with a photochromic dye during manufacturing or may be coated with a photochromic film at a desired, later time. For example, FIG. 4 shows a front and side view of voting ballot 10 inside an envelope 70 having an opaque window 80. Opaque window 80 may be made of a photochromic substance, as described above for the third ink 60, which is visible under normal light. In the embodiment shown, the user would fill out the voting ballot 10 and place the ballot 10 in the special return envelope 70. The user's confidential information will be hidden from view during mailing due to the use of window 80. Shining a photochromic excitation source on the envelope 70 in the case of use of photochromic inks or exposure of envelope 70 to a thermochromic excitation source in the case use of a thermochromic window or thermochromic film thereon will cause the window 80 to become clear. Thus, after this exposure, the information such as identification barcode 70, name 80 and signature may be seen through the clear window, as shown in FIG. 4.

Referring to FIG. 5, there is shown a diagrammatic view of a system 90 for printing the indicium on an item, such as a voting ballot, for example. The system generally comprises a print head system 100 operably connected to a controller 110. The print head system 100 is adapted to print at least three different inks onto the item. The print head system comprises a first supply 120 of the first ink 40, a second supply 130 of the second different ink 50 and a third supply 140 of the third different ink 60. As described above, the first ink 40 has a first color under normal daylight, such as black, blue or red, for example. Also as described above, the second ink 50 comprises a photochromic or thermochromic ink which is not visible under normal daylight, and the third different ink 60 comprises a photochromic or thermochromic ink which is visible under normal daylight.

In alternate embodiments, the printer head system 100 could comprises more or less than three ink supplies 120, 130, 140. In an alternate embodiment, the print head system could comprise a single print head adapted to pass by an area multiple times, such as a first one of time times for printing the first ink 40, a second one of the times for printing the second ink 50 and a third one of the times for printing the third ink 60.

The controller 110 is adapted for controlling application of the first, second and third inks by the print head system 100 on the item.

In one type of embodiment, the system can comprise an input device 150 which is coupled to the controller 110. The controller can be adapted to change the printed words, symbols or other markings based upon a signal or signals from the input device 150. This allows the visible or invisible printed words, symbols or other markings to be changed on demand by a user, or automatically, and new messages can be generated in real time. U.S. patent application publication no. US 2005/0087605 A1 discloses a suitable system for printing, the contents of which are hereby incorporated by reference.

Reading of the hidden information in the indicium 10 can be done visually by a user under an excitation source, such as a UV excitation source or thermochromic excitation source including suitable UV light or heat, and/or can be conducted with an automated system.

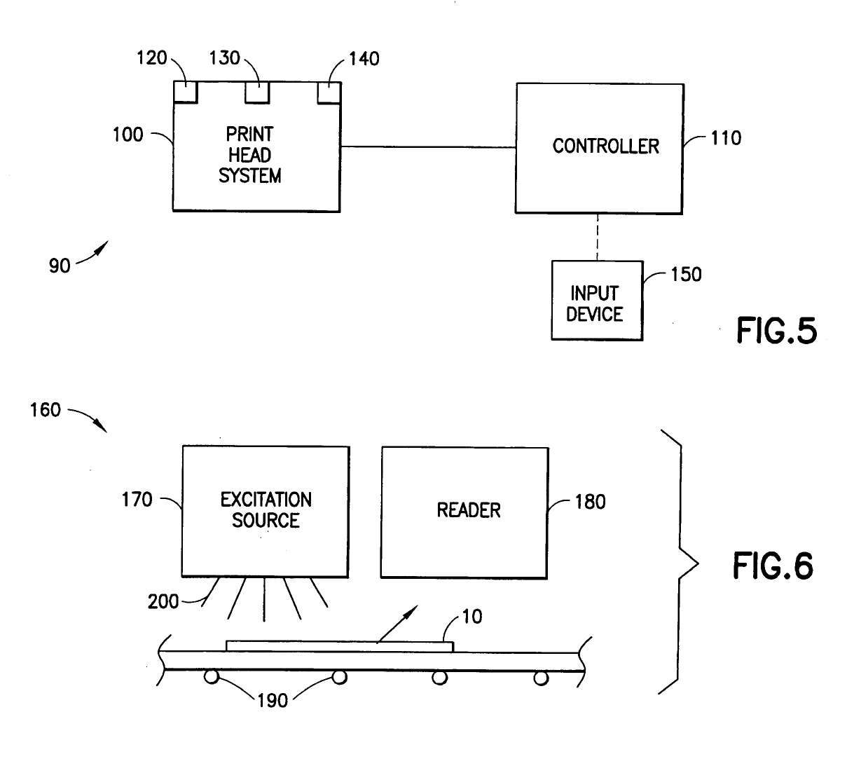

Referring now also to FIG. 6, an automated system 160 for reading the hidden information in the indicium 10 is shown. The automated system 160 comprises an excitation source 170, a reader or scanner 180, and a transport system 190 for transporting an item having the indicium 10. The transport system 190 could comprise any suitable type of document transport system. In an alternate embodiment, the transport system 190 might not be provided, such as when the excitation source 170 and reader 180 are contained in a hand-held device. The excitation source 170 is adapted to direct excitation radiation 200 towards the indicium 10. The excitation source 170 and type of excitation radiation 200 will be dependent on type of inks 50, 60 which is used; generally including certain ultraviolet excitation energy or heat at a desired activation temperature based upon the type of ink employed. Examples of thermochromic excitation sources include heat lamps and other suitable heating devices. The reader 180 is adapted to read the image from inks 50, 60 and send a signal corresponding to the image to another component, such as a processor for processing the image. In alternate embodiments, any suitable type of device or method for subjecting the indicium 10 to an excitation source and for detecting the image and sending a signal to another component corresponding to the image could be provided.

It should be understood that the foregoing description is only illustrative of the invention. Various alternatives and modifications can be devised by those skilled in the art without departing from the invention. Accordingly, the invention is intended to embrace all such alternatives, modifications and variances which fall within the scope of the appended claims.

What is claimed is:

1. A printed indicium comprising:
a first section comprising a first ink having a first color under normal daylight; and
a second section comprising a second different ink, wherein the second different ink comprises a photochromic or thermochromic ink which is not visible under normal daylight, the second section further comprising a third different ink which comprises a photochromic or thermochromic ink which is visible under normal daylight.

2. The printed indicium as in claim 1, wherein the first ink and the third ink comprise a black or blue color.

3. The printed indicium as in claim 1, wherein the printed indicium comprises voting information on a voting ballot.

4. The printed indicium as in claim 3, wherein the first section comprises voting candidate information.

5. The printed indicium as in claim 3, wherein the second section comprises a bar code printed with the second different ink and user information printed with the second different ink.

6. The printed indicium as in claim 5, wherein the user information is voter information including at least one of the voter's name and address.

7. The printed indicium as in claim 3, wherein the second section comprises a solid, signature block printed with the third different ink.

8. A system for printing indicium on an item, the system comprising:
a print head system adapted to print at least three different inks onto the item, the print head system comprising: a first supply of a first ink having a first color under normal daylight; a second supply of a second different ink, the second different ink comprising a photochromic or thermochromic ink which is not visible under normal daylight; and a third supply of a third different ink, the third different ink comprising a photochromic or thermochromic ink which is visible under normal daylight; and
a controller for controlling application of the first, second and third inks by the print head system on the item, wherein the controller is adapted to print the inks such that the first and third inks are visible under normal daylight and the second ink is not visible under normal daylight, and the third ink is not visible when exposed to a photochromic or a thermochromic excitation source and the second ink is visible when exposed to a photochromic or a thermochromic excitation source.

9. The system as in claim 8, wherein the print head system comprises at least three print heads.

10. A method of printing indicium on an item comprising steps of:
printing a first marking on the item in a first section with a first ink, the first ink having a first color under normal daylight;
printing a second marking on the item in a second section with a second different ink comprising a photochromic or thermochromic ink which is not visible under normal daylight; and
printing a third marking on the item in the second section with a third different ink comprising a photochromic or thermochromic ink which is visible under normal daylight.

11. The method of printing of claim 10, wherein the step of printing a first marking comprises printing candidate information as the first marking; the step of printing a second marking comprises printing at least one of a bar code and voter identification information as the second marking; and the step of printing a third marking comprises printing a signature block in which a voter inserts a signature as the third marking.

12. A voting article comprising:
an envelope having an opaque window, the opaque window comprising a photochromic or thermochromic material;
a voting ballot located inside the envelope, the voting ballot comprising a first section comprising a first ink having a first color under normal daylight; and a second section comprising a second different ink, wherein the second different ink comprises a photochromic or thermochromic ink which is not visible under normal daylight, the second section further comprising a third different ink which comprises a photochromic or thermochromic ink which is visible under normal daylight;
wherein user information including at least one of a barcode, voter's name, address and signature is printed on the ballot with the second different ink and is not visible through the window until activated by a suitable photochromic or thermochromic excitation source.

13. The voting article of claim 12, wherein the ballot comprises voting candidate information printed with the first ink in the first section.

14. The voting article of claim 12, wherein the second section comprises the bar code, voter's name, address and signature printed with the second different ink.

15. A method for hiding and verifying information in a voting system using a photochromic or thermochromic ink comprising:
printing a first marking on a voting ballot in a first section with a first ink, the first ink having a first color under normal daylight, wherein the step of printing a first marking includes printing candidate information as the first marking;
printing a second marking on the voting ballot in a second section with a second different ink comprising a photochromic or thermochromic ink which is not visible under normal daylight, wherein the step of printing a second marking comprises printing at least one of a bar code and voter identification information as the second marking;
printing a third marking on the voting ballot in the second section with a third different ink comprising a photochromic or thermochromic ink which is visible under normal daylight, wherein the step of printing a third marking comprises printing a signature block in which a voter inserts a signature as the third marking; and
verifying the authenticy of the voting ballot by subjecting the second ink and the third ink to a photochromic or thermochromic excitation source by a governing body to expose the voter identification information and voter signature.

16. The method of claim 15, wherein the verifying step comprising subjecting the second ink and the third ink to UV black light or heat.
